(19) United States
(12) Patent Application Publication
(10) Pub. No.: US 2023/0318820 A1
(43) Pub. Date: Oct. 5, 2023

(54) DYNAMIC DETERMINISTIC USER PASSWORD GENERATION

(71) Applicant: ALTOPASS, INC., Menlo Park, CA (US)

(72) Inventors: Eugene FOOKSMAN, Menlo Park, CA (US); Guy Leroy BARNHART-MAGEN, Herzliya (IL)

(73) Assignee: AltoPass, Inc., Menlo Park, CA (US)

(21) Appl. No.: 18/023,032

(22) PCT Filed: Aug. 23, 2021
(86) PCT No.: PCT/IB2021/057702

§ 371 Date: Feb. 24, 2023

Related U.S. Application Data
(60) Provisional application No. 63/070,845, filed on Aug. 27, 2020.

(51) Int. Cl. H04L 9/08; H04L 9/32

(52) U.S. Cl. CPC H04L 9/0863; H04L 9/0869; H04L 9/0894; H04L 9/3226

(57) ABSTRACT

There is provided a computer implemented method for dynamic deterministic generation of a user password for access to a secure application, comprising: receiving from a user interface, a master phrase entered by a user, and an indication of one secure application of a plurality of secure applications for access by the user, receiving a master salt associated with an indication of the user, dynamically computing a master key from the master phrase and the master salt, receiving a service payload associated with an indication of the one secure application and the indication of the user, dynamically computing a service password from the master key and the service payload, and providing the service password for accessing the one secure application.

### RELATED APPLICATION

This application claims the benefit of priority of U.S. Provisional Pat. Application No. 63/070,845 filed on Aug. 27, 2020, the contents of which are incorporated herein by reference in their entirety.

### FIELD AND BACKGROUND OF THE INVENTION

The present invention, in some embodiments thereof, relates to cybersecurity and, more specifically, but not exclusively, to systems and methods for managing passwords of a user for accessing secure applications.

Secure application, for example, banking websites, email accounts, and company servers, require a user to enter a password to obtain access. Passwords are prone to malicious attack, for example, by phishing and/or breaking into a data storage device storing the passwords. Moreover, multiple passwords to access multiple secure applications are difficult for a user to remember. Simple passwords and/or using the same password for multiple different applications is insecure and prone to malicious attack.

### SUMMARY OF THE INVENTION

According to a first aspect, a computer implemented method for dynamic deterministic generation of a user password for access to a secure application, comprises: receiving from a user interface, a master phrase entered by a user, and an indication of one secure application of a plurality of secure applications for access by the user, receiving a master salt associated with an indication of the user, dynamically computing a master key from the master phrase and the master salt, receiving a service payload associated with an indication of the one secure application and the indication of the user, dynamically computing a service password from the master key and the service payload, and providing the service password for accessing the one secure application.

According to a second aspect, a computer implemented method of setting up a master phrase and service password of a user for access to a secure application, comprises: receiving from a user interface, a master phrase entered by a user, and an indication of one secure application of a plurality of secure applications for access by the user, generating a master salt, storing the master salt in association with an indication of the user, dynamically computing a master key from the master phrase and the master salt, generating a service payload, storing the service payload in association with an indication of the one secure application and the indication of the user, dynamically computing a service password from the master key and the service payload, and providing the service password for setting up an account of the user on the one secure application for future secure access to the one secure application.

In a further implementation form of the first aspect, each one of a plurality of service passwords for accessing a plurality of secure applications is computed from the master salt and a respective service mask stored in the service payload associated with a respective secure application, wherein each secure application is associated with a certain service password and a certain service payload storing the service mask.

In a further implementation form of the first aspect, the master key is computed by inputting the master phrase and the master salt into a key derivation function (KDF) that generates the master key of a predefined fixed size.

In a further implementation form of the first aspect, further comprising: computing a path key from a KDF that receives the master salt and master phrase as input, receiving a master-verification-salt associated with the indication of the user, computing a dynamic master hash of the pathkey and the master-verification-salt, receiving a master-hashkey associated with the user, the master-hashkey computed as a cryptographic hash of the master phrase and the master salt, verifying the path key as the master key when the dynamic master hash matches the master-hashkey.

In a further implementation form of the first aspect, further comprising: in response to the verifying, the verifying the path key as the master key comprises computing the master key by applying a mask to the path key.

In a further implementation form of the first aspect, further comprising: in response to the computation of the service password, deleting the master phrase, the master key, and the service password, from a memory.

In a further implementation form of the first aspect, the master phrase entered by a user comprises a recovery phrase corresponding to the master phrase, and further comprising: receiving a recovery indication indicating that the master phrase entered by the user comprises the recovery phrase, receiving a recovery salt associated with the indication of the user, and wherein dynamically computing the master key from the master phrase and the master salt comprises dynamically computing the master key from the recovery phrase and the recovery salt.

In a further implementation form of the first aspect, further comprising: computing a path key from a KDF that receives the recovery salt and recovery phrase as input, receiving a recovery-verification-salt associated with the user, computing a dynamic recovery hash of the path key and the recovery-verification-salt, receiving a recovery-hashkey associated with the user, the recovery-hashkey computed as a cryptographic hash of the recovery phrase and the recovery salt, in response to the dynamic recovery hash matching the recovery-hashkey, computing the master key by applying a recovery mask to the path key.

In a further implementation form of the first aspect, the recovery phrase comprises a seed phrase of a list of words, and further comprising mapping using a mapping function the seed phrase to at least one recovery number, wherein the path key is computed from the KDF that receives the recovery salt and the at least one recovery number.

In a further implementation form of the first aspect, dynamically computing the service password from the master key and the service salt, comprises: receiving a service seed associated with the indication of the certain one secure application and the indication of the user, receiving a service payload associated with the indication of the certain one secure application and the indication of the user, generating a seed by computing an operation between the service seed and the master key, initialize a pseudo-random number generator (PRNG) with the seed, generating a service mask by extracting a plurality of service blocks from the PRNG, generating a payload by computing an operation between the mask and the service payload, and dynamically computing the service password from the payload and service payload.

In a further implementation form of the first aspect, further comprising: computing a dynamic service hash of the master key and the service payload, receiving a service integrity value stored in association with an indication of the certain one secure application and the indication of the user, verifying that the dynamic service hash matches the service integrity value.

In a further implementation form of the first aspect, dynamically computing the service password from the payload and service payload comprises: receiving a password seed stored in the service payload, receive a set of password constraint rules stored in the service payload, set a temporary seed to the password seed, initialize an alphanumeric data structure with default values, in a plurality of iterations: instantiate a PRNG with temporary seed, for each constraint rule of the set of password constraint rules, select one character from the alphanumeric data structure, and place the selected one character in a temporary array, for another plurality of iterations according to a target number of characters in the service password, randomly select one character from the alphanumeric data structure and place the selected one character in the temporary array, shuffle the temporary array, apply each of a plurality of heuristic functions to the temporary array, and provide the temporary array as the service password.

In a further implementation form of the first aspect, the plurality of heuristic functions are selected from the group consisting of: repeating characters, linear relationship between alphanumeric characters, and a start with at least one digit.

In a further implementation form of the first aspect, at least one of the plurality of heuristic functions fails, set a temporary seed to a random value obtained from the PRNG, clear the temporary array, and repeat plurality of the iterations.

In a further implementation form of the second aspect, further comprising: computing a path key from a KDF that receives the master salt and master phrase as input, generating a master-verification-salt, storing the master-verification-salt in association with the indication of the user, computing a dynamic master hash as a cryptographic hash of the pathkey and the master-verification-salt, and storing the dynamic master hash in association with the indication of the user.

In a further implementation form of the second aspect, further comprising: generating a mask for application to the path key for generation of a master key, and storing the mask in association with the indication of the user.

In a further implementation form of the second aspect, generating the mask comprises: generating a random value for the master key, and storing the mask as the outcome of an XOR mathematical operation of the master key and the path key.

In a further implementation form of the second aspect, further comprising: generating a recovery phrase, wherein when the recovery phrase is provided instead of the master phrase, the master key generated from the recovery phrase is same as the master key generated from the master phrase, generating a recovery salt, and storing the recovery salt in association with a recovery indication and the indication of the user.

In a further implementation form of the second aspect, further comprising: generating at least one recovery number, mapping using a mapping function the at least one recovery number to a seed phrase of a list of words, and presenting on a display and/or printing the seed phrase, wherein the recovery phrase comprises the seed phrase.

In a further implementation form of the second aspect, further comprising: generating a recovery-verification-salt, storing the recovery-verification-salt in association with the recovery indication and the indication of the user, computing a path key from a KDF that receives the recovery salt and recovery phrase as input, computing a recovery-hashkey as a cryptographic hash of the path key and the recovery-verification salt, storing the recovery-hashkey in association with the recovery indication and the indication of the user, and computing a recovery mask that when applied to the path key generates the master key.

In a further implementation form of the second aspect, dynamically computing the service password from the master key and the service salt, comprises: receiving a service seed associated with the indication of the certain one secure application and the indication of the user, receiving a service payload associated with the indication of the certain one secure application and the indication of the user, generating a seed by computing an XOR operation between the service seed and the master key, initialize a pseudo-random number generator (PRNG) with the seed, generating a service mask by extracting a plurality of service blocks from the PRNG, generating a payload by computing an XOR operation between the mask and the service payload, and dynamically computing the service password from the payload and service payload.

In a further implementation form of the second aspect, further comprising: computing a dynamic service hash of the master key and the service payload, receiving a service integrity value stored in association with an indication of the certain one secure application and the indication of the user, verifying that the dynamic service hash matches the service integrity value.

In a further implementation form of the second aspect, dynamically computing the service password from the payload and service payload comprises: receiving a password seed stored in the service payload, receive a set of password constraint rules stored in the service payload, set a temporary seed to the password seed, initialize an alphanumeric data structure with default values, in a plurality of iterations: instantiate a PRNG with temporary seed, for each constraint rule of the set of password constraint rules, select one character from the alphanumeric data structure, and place the selected one character in a temporary array, for another plurality of iterations according to a target number of characters in the service password, randomly select one character from the alphanumeric data structure and place the selected one character in the temporary array, shuffle the temporary array, apply each of a plurality of heuristic functions to the temporary array, and provide the temporary array as the service password.

In a further implementation form of the second aspect, the plurality of heuristic functions are selected from the group consisting of: repeating characters, linear relationship between alphanumeric characters, and a start with at least one digit.

In a further implementation form of the second aspect, at least one of the plurality of heuristic functions fails, set a temporary seed to a random value obtained from the PRNG, clear the temporary array, and repeat plurality of the iterations.

In a further implementation form of the second aspect, further comprising: generating the service seed, storing the service seed in association with the indication of the certain one secure application and the indication of the user, receiving a plurality of password constraint rules defined by the certain one secure application, generating a password seed, generating the service payload, including the plurality of password constraint rules defined by the certain one secure application, and the password seed, and storing the service payload in association with an indication of the certain one secure application and the indication of the user.

In a further implementation form of the second aspect, further comprising: computing the service integrity value as a hash of the master key and the service payload, and storing the service integrity value in association with an indication of the certain one secure application and the indication of the user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for setting up and using a dynamic deterministic generation of a user password for access to a secure application, in accordance with some embodiments of the present invention;

FIG. 2 is a block diagram of a system for dynamic deterministic generation of a user password for access to a secure application, in accordance with some embodiments of the present invention;

FIG. 3 is an exemplary dataflow for dynamically computing a master key from a master phrase and a previously computed master salt, in accordance with some embodiments of the present invention;

FIG. 4 is a dataflow diagram depicting exemplary dataflow for dynamically computing a master key from a recovery phrase, in accordance with some embodiments of the present invention;

FIG. 5 is a dataflow diagram of an exemplary process for dynamically computing any one of multiple service passwords from a single same MasterKey and a service salt, in accordance with some embodiments of the present invention;

FIG. 6 is a flowchart of a set-up process for computing data for obtaining a master key from a master phrase, in accordance with some embodiments of the present invention;

FIG. 7 is a flowchart of a set-up process for computing data for obtaining a service password from a master phrase, in accordance with some embodiments of the present invention; and

FIG. 8 is a dataflow diagram of an exemplary process for setting up an encrypted data channel for communication between a device and a browser, via a backend, in accordance with some embodiments of the present invention.

### DESCRIPTION OF SPECIFIC EMBODIMENTS OF THE INVENTION

The present invention, in some embodiments thereof, relates to cybersecurity and, more specifically, but not exclusively, to systems and methods for managing passwords of a user for accessing secure applications.

An aspect of some embodiments of the preset invention relates to systems, methods, an apparatus, and/or code instructions (e.g., stored on a memory and executable by one or more hardware processors) for dynamic deterministic generation of a user password for access to a secure application. A master phrase is provided entered by a user. An indication of one secure application of multiple secure applications for access by the user is provided. It is noted that one of multiple unique user passwords, each for accessing another different secure application, may be generated in response to the single same master phrase. By using the same master phrase, the user may access any one of multiple secure applications, without requiring the user to remember and/or manage multiple different password for the multiple secure applications. A master salt associated with an indication of the user is obtained. A master key is dynamically computed from the master phrase and the master salt. A service payload associated with an indication of the one selected secure application and the indication of the user, is obtained. A service password is dynamically computed from the master key and the service payload. The service password is provided for accessing the one secure application.

At least some implementations of the systems, methods, apparatus, and/or code instructions described herein address the technical problem of cybersecurity, in particular, the technical problem of cybersecurity for management of user passwords to access secure processes and/or applications, for example, banking web sites, access a remote server of an employer, and an email application. It is difficult for a human to remember multiple passwords, especially when some of these passwords are not used very often. As a result, people tend to use the same password, simple variations of the same base password, or simple easy to remember passwords the basis of which may be found on the internet (e.g., birthday). Such passwords are vulnerable to malicious attack. For example, when the same password is used multiple times, a hacker that is able to obtain the password from one source now has access all applications that use the same password. In another example, simple passwords may be quickly hacked and/or figured out from information of the user available on the internet.

Different approaches have been developed to improve security of user passwords. However, such approaches are still vulnerable to malicious attack. For example, approaches that store passwords in a cloud and/or other external data storage may be vulnerable due to synchronization of the password between devices, and/or to malicious attack on the cloud storage. Syncing metadata in the cloud in order to facilitate backup and multi-device support is a feature of some good existing password management approaches. However, syncing and storing password files in the cloud creates a potential for numerous attacks should an attacker get access to that file.

At least some implementations of the systems, methods, apparatus, and/or code instructions described herein improve the technology of cybersecurity, in particular, cybersecurity for management of user passwords. In at least some implementations, the improvement is eliminating the requirement to store user passwords in the cloud and/or other external data storage device. It is noted that at least some implementations, the user entered password (also referred to herein as master phrase) may be temporarily stored in a memory of a device for a short time interval, in order to dynamically compute the service password to obtain access to the secure application.

The technical problem described herein, and/or the improvement to the technology, is provided, at least by the storage of multiple different service payloads (e.g., as described herein, including secret data, and/or plaintext random values such as salts, and/or other values), each associated with an independent service password for accessing a respective secure application. Each respective service password is not stored, but is dynamically computed for the respective secure application using the same master salt and master phrase. At least some implementations described herein provide a secure approach for backing up the master phrase in case the master phrase is lost (e.g., via the recovery mechanism described herein). At least some implementations described herein provide high security by not storing any information about the secret data in a memory for a significant amount of time (e.g., data is quickly removed from memory when no longer needed). At least some implementations described herein enable for entire user accounts and/or selected service payloads to be synchronized across multiple devices and/or across multiple accounts of the users for accessing different secure applications, with high security.

The technical security problem described herein, and/or the improvement to the security technology, is provided, at least by computation and storage of multiple different salts and/or seeds and/or other data, which are dynamically used to compute the master key and/or service password, as described herein. The stored multiple different salts and/or seeds and/or other data, when used with the master phrase (which is not stored in a memory for a significant amount of time), provide multiple levels of high security which are difficult or impossible to break through. The stored multiple different salts and/or seeds and/or other data may be stored in plain text and publicly accessed, since without the master phrase (which is not stored in a memory for a significant amount of time), such data cannot be used to determine the service password(s). For example, in comparison to other approaches that simply store the web address of the secure application being accessed and/or store a simple counter number, which provide low levels of security. In another example, other approaches do not use KDFs, for example, since usage of a KDF may open the implementation to a brute force attack, and/or in order to avoid storage of any data at all (even salts), which reduces security and/or which cannot be used to generate multiple different service passwords using the same master phrase. Even though at least some implementations described herein use a KDF, other security measures are implemented to prevent and/or reduce risk of brute force attacks.

The technical security problem described herein, and/or the improvement to the security technology, is provided, at least by the key ladder design of several steps, which is triggered from a user provided master phrase, which is expected to be known only to the user. A path key, which is an intermediate key that provides for multiple keys/paths to derive the same master key, independently may be generated from the master phrase. A master key is computed from the master phrase and/or path key, for example, using a KDF. A service key is computed from the master key (e.g., based on a PRNG with a seed value supplied by previous features). A service password for accessing a certain secure application is dynamically computed from the service key, and optionally from constraints, heuristic functions, and a PRNG.

At least some implementations of the systems, methods, apparatus, and/or code instructions described herein address the technical problem of improving the user experience of login into to multiple different secure applications and/or secure web sites. At least some implementations of the systems, methods, apparatus, and/or code instructions described herein provide an improved user experience for logging into to multiple different secure applications and/or secure web sites by a designed user interface, optionally a graphical user interface (GUI), by receiving the master phrase from the user, and optionally receiving an indication of which secure application the user wishes to access, and dynamically computing the service password for the selected secure application. The user does not need to remember and/or manager multiple different service passwords.

At least some implementations of the systems, methods, apparatus, and/or code instructions described herein may provide one or more of the following potential advantages:
Passwords are derived in real time from a user supplied master phrase.
User passwords are not stored in a long term memory, for example, not stored on a server and/or on a client terminal of the user. Any temporary storage of user passwords is for short durations and the password may then be deleted from the memory.
The master key may be kept secret from the user, and does not need to be shared with anyone.
Only the user has access to their unencrypted data.
Metadata (e.g., salt, payload) may be synchronized across multiple devices (e.g., client terminals, laptop, smartphone) and a browser. Data transferred between the device and the browser may be hidden from a backend server providing an encrypted connection between the device and browser.
Metadata (e.g., salt, payload) stored on a server and/or on the client terminal may be cryptographically protected and/or designed to hold a minimal amount of information and/or be resistant to brute force attacks.
No password based encryption scheme is used. Data is not encrypted using a password.
Only input from user is the Master Phrase. User provides an indication of the target secure application for which the service password is generated, for example, by clicking on an icon of the target secure application from a list of secure applications that the user has signed up for.
Tradeoff between high security and fast computations even on a mobile device. For example, computing the service password from the master phrase is designed to take about 1 second on medium end devices, about 0.5 seconds on high end devices, and about 2 seconds on low end devices.

One or more of the following items represent an exemplary threat model. For each item, at least some embodiments described herein are designed to counter the respective item, as detailed:
An attacker/adversary would like to gain access to the credentials in a stored file - In at least some embodiments, no credentials are stored in a file.
The attacker does not have access to the master phrase or the recovery phrase - In at least some embodiments, only the user knows the master phrase and/or the recovery phrase. The master phrase and/or recovery phrase are not stored anywhere for long term storage, and any temporary storage is short term and then deleted.
The attacker has access to a stored data file, and all its contents - In at least some embodiments, access to stored data provide no data that may be used to obtain user passwords, since the master phrase and/or recovery phrase are not stored.
The attacker has no access to a device as described herein, which the attack may use to perform memory forensics, side-channel analysis, etc. - In at least some embodiments, even access to the device and its memory provides not data that may be used to obtain the user passwords, since the master phrase and/or recovery phrase are not stored.
The attacker has access/knowledge of algorithms and protocols in use- In at least some embodiments, knowing algorithms and protocols is unhelpful without the master phrase, which is only known by the user and not stored anywhere.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

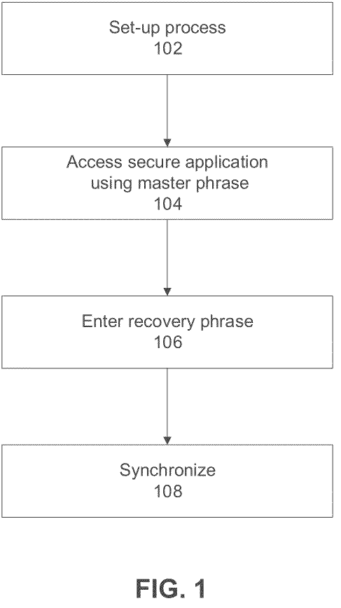

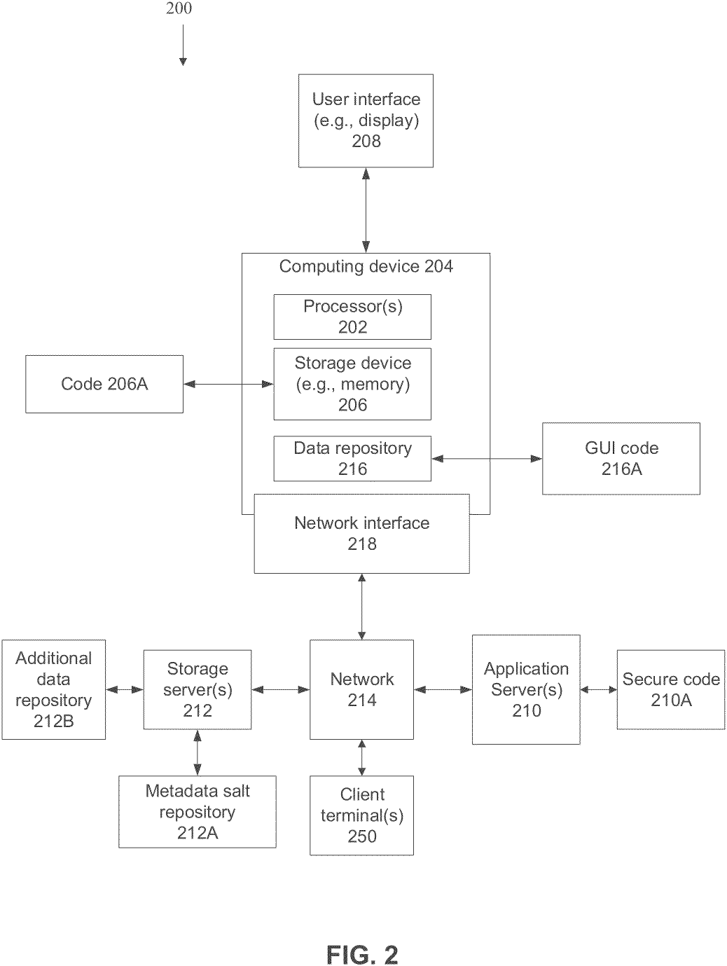

Reference is now made to FIG. 1, which is a flowchart of a method for setting up and using a dynamic deterministic generation of a user password for access to a secure application, in accordance with some embodiments of the present invention. Reference is also made to FIG. 2, which is a block diagram of a system 200 for dynamic deterministic generation of a user password for access to a secure application, in accordance with some embodiments of the present invention. System 200 may implement the acts of the method described with reference to FIG. 1, by processor(s) 202 of a computing device 204 executing code instructions 206A stored in a storage device 206 (also referred to as a memory and/or program store).

Multiple architectures of system 200 based on computing device 204 may be implemented. In an exemplary implementation, computing device 204 storing code 206A may be implemented as an example of one client terminal 250, for example, a virtual machine, a desktop computer, a thin client, and/or a mobile device (e.g., a Smartphone, a Tablet computer, a laptop computer, a wearable computer, glasses computer, and a watch computer). It is noted that computing device 204 may be implemented, for example, one or more and/or combination of: a group of connected devices, a server, a virtual server, a computing cloud, a virtual machine, and a network node.

Code 206A may be implemented, for example, as a standalone application, an add-on to an existing application, and/or a plug-in to an existing application, for example, a plug-in to a web browser.

Computing device 204 may interface, over a network 214, with one or more of a storage server 212, an application server(s) 210, and/or client terminals 250.

Computing device 204 may be used by a user in order to access one or more secure code (e.g., sometimes referred to herein as secure application) 210A, for example, secure website such as a bank website, secure files stored on a server of an employer, a secure application, and/or user account, such as an email account and/or social network account, stored on one or more server(s) 210. In another example, secure code 210A may represent other securely stored data (e.g., of the user), for example, keys, credit card numbers, or other information that the user wishes to keep secret, and is accessed by the master phrase.

Computing device 204 may access storage server(s) 212 to access metadata salt repository 212A and/or additional data repository 212B to obtain salt metadata and/or additional other data (e.g., included in the service payloads) in order to dynamical generate service level passwords for accessing secure code 210A, as described herein. Storing metadata salt repository 212A and/or additional data repository 212B on storage server(s) 212 enables access to secure code 210A from multiple different client terminals. Alternatively or additionally, metadata salt repository 212A and/or additional data repository 212B are locally stored by computing device 204, for example, stored on data repository 216.

Alternatively, in some embodiments, computing device 204 may be implemented as one or more servers that provides services to multiple client terminals 250 over a network 214. For example, client terminal 250 sends the master phrase to computing device 204 and receives the dynamically computed service phrase.

Communication between computing device 204 and one or more of storage server(s) 212, application server(s) 210, and client terminal(s) 250 over network 212 may be implemented, for example, via an established secure link, via an application programming interface (API), software development kit (SDK), functions and/or libraries and/or add-ons added to existing applications executing on computing device 204, an application for download and execution on computing device 204, function and/or interface calls to code executed by computing device 204, and a remote access session executing on a web site hosted by storage server(s) 212 accessed via a web browser executing on computing device 204.

Hardware processor(s) 202 of computing device 204 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 202 may include a single processor, or multiple processors (homogenous or heterogeneous) arranged for parallel processing, as clusters and/or as one or more multi core processing devices.

Storage device (e.g., memory) 206 stores code instructions executable by hardware processor(s) 202, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 206 stores code 206A that implements one or more features and/or acts of the method described with reference to FIG. 1 when executed by hardware processor(s) 202.

Computing device 204 may include data repository (e.g., storage device(s)) 216 for storing data, for example, GUI code 216A, Metadata salt repository 212A, and/or additional data repository 212B. Data storage device(s) 216 may be implemented as, for example, a memory, a local hard-drive, virtual storage, a removable storage unit, an optical disk, a storage device, and/or as a remote server and/or computing cloud (e.g., accessed using a network connection).

Network 214 may be implemented as, for example, the internet, a local area network, a virtual network, a wireless network, a cellular network, a local bus, a point to point link (e.g., wired), and/or combinations of the aforementioned.

Computing device 204 may include a network interface 218 for connecting to network 214, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 204 include and/or are in communication with one or more physical user interfaces 208 that include a mechanism for user interaction, for example, to enter data (e.g., enter the master phrase) and/or to view data (e.g., the dynamically computed service passwords).

Exemplary physical user interfaces 208 include, for example, one or more of, a touchscreen, a display, gesture activation devices, a keyboard, a mouse, and voice activated software using speakers and microphone.

Storage server(s) 212 and/or application server(s) 210 and/or client terminal(s) 250 may be implemented as, for example, a client terminal, a server, a virtual server, a virtual machine, a computing cloud, a mobile device, a desktop computer, a thin client, a Smartphone, a Tablet computer, a laptop computer, a wearable computer, glasses computer, and a watch computer.

Referring now back to FIG. 1, at 102, an initialization process (also referred to herein as set-up process) is performed for generating a service password and service payload for accessing a certain secure application using a master phrase provided by a user. The service payload may be stored as a metadata file. The metadata file may be stored on one or more of the user’s devices, and optionally synchronized between devices, and/or centrally stored in a data storage service (e.g., cloud storage). The metadata file may be stored in clear text, since it does not necessarily store any usable secrets, for example, the stored salts are randomly generated values.

The service payload may be automatically generated, for example, by code that analyzes a website of the secure application and/or receives instructions from the website, for example, to determine the web address of the website, and/or password policies (e.g., minimum password length, presence of certain groups of characters such as capital letters, digits, and/or special symbols). The service payload may be kept up to date and/or dynamically updated, for example, by the code, by period updates from the website, and/or manually by a user.

The initialization process may be iterative performed for generating a respective unique service password and respective unique service payload for each respective secure application, using the same common master phrase provided by the user.

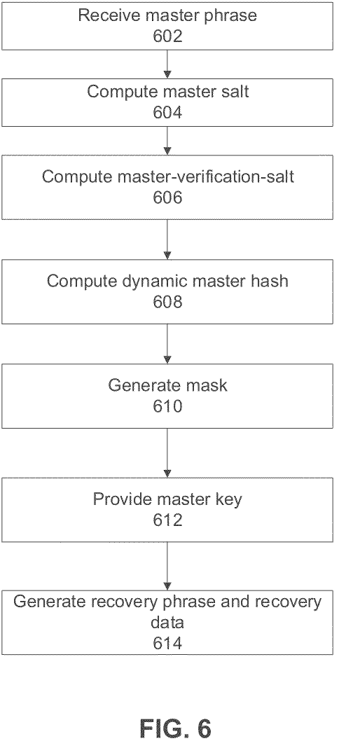

An exemplary initialization process is described below with reference to FIG. 6. In summary, the following is performed: A TRNG seed may be generated, and used to instantiate the PRNG. The Master Phrase is obtained from the user and may be stored in a UserInput data structure. The KDF is fed as input the master phrase and the PathSalt (also referred to herein as master salt) to derive the PathKey. The hash of PathKey with VerifySalt is computed and stored as HashKey. A random value is generated for MasterKey, a mathematical operation (e.g., XOR) is applied to it with PathKey and the outcome is stored in Mask. The summary process may be represented by the following pseudocode:
input = UserInput()
PathKey = KDF(PathSalt, input)
HashKey = Hash(VerifySalt II PathKey)
MasterKey = RAND(64)
Mask = MasterKey ^ PathKey

The master phrase may be entered by the user, for example, typed into a keyboard, spoken into a microphone (e.g., using speech to text code), using biometric data (e.g., based on an image of a face of the person), and/or combinations thereof.

The certain secure application may be selected by the user, for example, from a list of secure applications, and/or by accessing a web page of the secure application hosted by a web server. The secure application may be locally stored on a client terminal of the user and/or on a network, such as the internet and/or a private network.

The security root of trust is based on a strong master phrase. The user may be advised of one or the following items when selecting the master phrase. First, to avoid using a weak or predictable master phrase that may break the security model. Second, the master phrase should be selected to be random and/or unique enough to resist dictionary attacks and brute force attacks. Third, the master phrase and recovery phrase should be known only to the user, so that the attacker does not have access to the master phrase and recovery phrase.

Secret information (e.g., computed master key, computer service key, master phrase) stored in a memory may be securely cleared after the secret information is no longer needed, and prior to the memory being released. The secret information may exist in the memory for the shortest amount of time. A check may be performed to determine whether the secret information is still needed. When the secret information is no longer needed, the secret information may be securely cleared. Secret information may be cleared for example, from device secure storage, device memory, clipboard and any other location the secret information is being used. Memory regions that store the secret information may be cleared, for example, by being overwritten for example with random information prior to being released such as at an end of a scope. The clear function may clear that memory so a mechanism to enforce this may use a dummy function that operates on that memory (e.g. a conditional that return the error code as a function of that memory block).

At 104, one of multiple secure applications is accessed. The secure application is accessed using a master phrase provided by the user, and a unique service password that is dynamically computed from the master phrase and a service payload. The service password may be automatically transmitted to the secure application (e.g., using approaches described herein) and/or the service password may be presented on a display and copied and pasted by the user into the relevant “password” field of the secure application.

The user may indicate whether an input provided by the user (e.g., via the GUI) is a master phrase, or a recovery phrase. For example, the user clicks on an icon or presses a button to indicate the master phrase or recovery phrase.

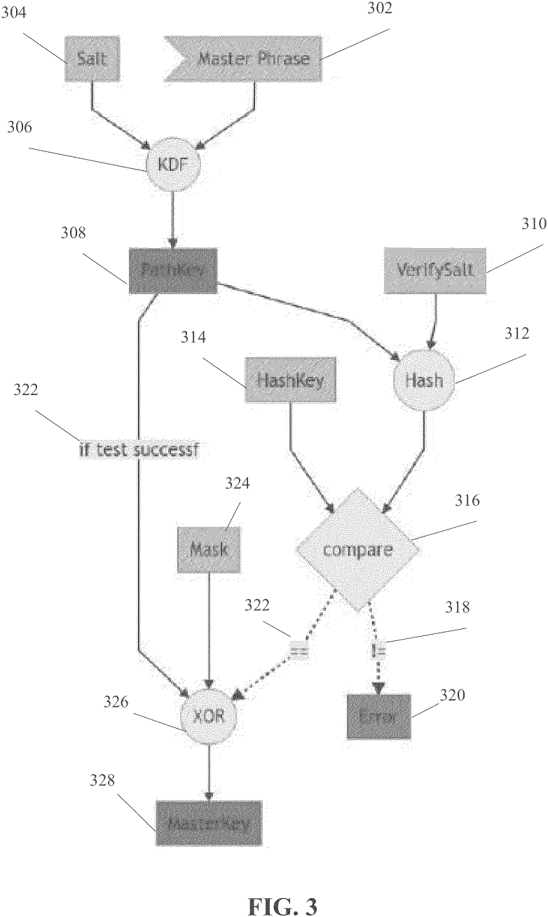

In response to an indication that the master phrase is entered, a normal derivation path for deriving the master key is triggered, for example, as described with reference to FIG. 3.

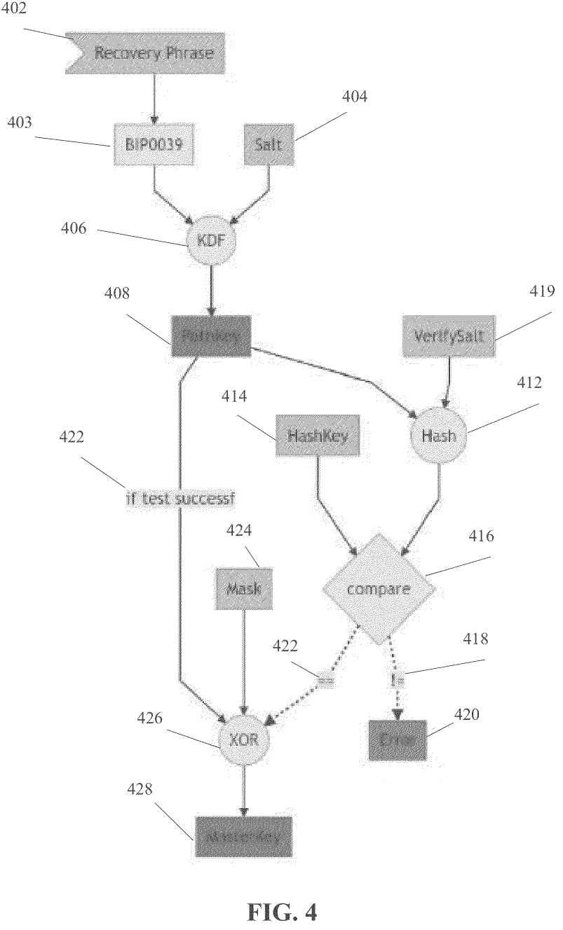

Alternatively, at 106, in response to an indication that the recovery phrase is entered, a recovery path for deriving the master key is triggered, for example, as described with reference to FIG. 4. The user may change the master phrase, and/or generate the service password using the recovery phrase.

The recovery phrase (that is generated and then entered) may be, for example, a QR code and/or a mnemonic string, and/or other implementations.

Optionally, at 108, the service accounts of the same user (i.e., for accessing multiple different secure applications using the same master phrase) may be synchronized across multiple different devices (e.g., client terminals, mobile devices, cloud storage), for example, using the payloads and/or salts, by centrally storing the payload and/or salts and/or synchronizing the same stored payload and/or salt on different devices. It is noted that when service payloads are stored for different services, certain service payloads may be selected for synchronization, while others are not necessarily selected for synchronization.

Reference is now made to FIG. 3, which depicts an exemplary dataflow for dynamically computing a master key from a master phrase and a previously computed master salt (computed during the initialization stage), in accordance with some embodiments of the present invention. The same master key is used to dynamically generate one of multiple service passwords for accessing any one of multiple secure applications that the user has signed up for, i.e., a unique service password is generated for one corresponding secure application.

At 302, the Master Phrase is received from the user. The master phrase may be temporarily stored in a memory as a UserInput parameter.

An indication of one secure application of multiple secure applications (for which service passwords have been created for the same master phrase) for access, is received, for example, the user clicks on an icon and/or accesses the web site of the secure application. It is noted that the indication of the secure application may be received earlier and/or later in the flow.

At 304, a master salt associated with an indication of the user is obtained.

The master salt has been computed during the initialization stage.

The master salt may be stored as clear text. The master salt may be stored as metadata in a metafile (e.g., configuration file, also referred to herein as file) associated with the user. The master salt may be stored, for example, on a server and/or on the client terminal of the user.

At 306, the master salt and the master phrase are inputted into a KDF. It is noted that the master phrase is not used directly. As described herein, a master key of selected size (e.g., 64 bytes, 128 bytes, or other sizes selected for security) is computed from the master phrase, optionally using a key derivation function (KDF). The KDF provides increased security, given the known hardness of the problem of reversing a KDF to find an input that generates the output of the KDF.

At 308, a PathKey is obtained as an outcome of the KDF that receives the master salt and master phrase as input. The PathKey represents the master key that is being validated before being designated as the master key. The PathKey is of a predefined fixed sized.

At 310, a VerifySalt (also referred to as a master-verification-salt) associated with an indication of the user is obtained. The VerifySalt has been computed during the initialization stage.

The VerifySalt may be stored as clear text. The VerifySalt may be stored in as metadata in a metafile associated with the user. The VerifySalt may be stored, for example, on a server and/or on the client terminal of the user.

At 312, the PathKey and the VerifySalt are inputted into a cryptographic hash function, for computing a dynamic master hash of the pathkey and the master-verification-salt.

The PathKey (i.e., master key) is cryptographically hashed using a hash function with a stored master salt, and compared to a stored salted hash of the master key. This helps to discourage decryption of services using a wrong value and providing a bad key. The hashing provides increased security, given the known hardness of the problem of reversing a cryptographic hash to find an input that generates the output of the hash function. An exemplary cryptographic hash function is SHA3-512, using salt values that may be 64 bytes and may be generated by the TRNG.

An exemplary true random number generator (TRNG) is now described. The TRNG may be used in one or more instances, as described herein. The TRNG may be based on a real source of randomness that is unpredictable. An operating system randomness source may be used as a basis for the TRNG. The operating system randomness may be mixed with other sources when available. Since there may be issues with the quality of sources of randomness in various systems multiple sources may be combined and/or mixed in order to increase overall entropy. When at the time the TRNG function is invoked the current quality of the randomness pool is unknown, other “weaker” randomness sources may be combined in order to get a stronger pool.

An exemplary pseudo-random number generator (PRNG) is now described. The PRNG may be used in one or more instances, as described herein. The PRNG may be based on a process that outputs a bitstream that seems random but is completely deterministic (also referred to as a deterministic random number generator (DRBG)). A strong and/or simple PRNG may be built around a HASH and/or an HMAC, and/or aligned with standards. As described with reference to the TRNG, multiple randomness sources may be mixed or a single randomness source may be used. The result of the mixing of multiple randomness sources (or a single source that is unmixed such as the operating system source) may be used as a seed for the PRNG. Such seeding may help a development perspective by making the testing easier for other components as well. The seed values may be at least 64 bytes, or 128 bytes, or other values.

At 314, a HashKey (also referred to herein as a master-hashkey) associated with the user is obtained. The HashKey has been computed during the initialization stage, as a cryptographic hash of the master phrase and the master salt.

The HashKey may be stored as clear text. The HashKey may be stored in as metadata in a metafile associated with the user. The HashKey may be stored, for example, on a server and/or on the client terminal of the user.

At 316, the outcome of the hash function (of 312) is compared to the HashKey. The comparison is performed for verifying the path key as the master key when the dynamic master hash matches the master-hashkey.

At 318, the outcome of the hash function (of 312) does not match the HashKey.

At 320, in response to the outcome of the hash function (of 312) does not match the HashKey, an error is generated. For example, an indication of the error is presented on the display. The user may be asked to re-enter the Master Phrase. The process terminates and may restart in response to the user re-entering the Master Phrase.

At 322, the outcome of the hash function (of 312) matches the HashKey.

At 324, a Mask is obtained.

At 326, in response to the outcome of the hash function (of 312) matching the HashKey, an operation (e.g., XOR) is applied to the mask and the PathKey.

At 328, the MasterKey is obtained by applying the mast to the path key, i.e., as the outcome of the operation (e.g., XOR) of the mask and the PathKey. The MasterKey may be stored in a memory, for example, in a hardware key storage, for caching or faster access, for example, with biometrics. The MasterKey may be securely removed from the memory and/or storage after a period of time when the MasterKey is no longer needed, as described herein.

The following is an exemplary pseudocode for generating the MasterPhrase, which may correspond to the dataflow depicted with reference to FIG. 3:
input = UserInput() // master passphrase or recovery phrase from user
PathKey = KDF(PathSalt, input)
hash = Hash(VerifySalt II PathKey)
if hash != HashKey: error() // Wrong input exit
MasterKey = Mask ^ PathKey

Reference is now made to FIG. 4, which is a dataflow diagram depicting exemplary dataflow for dynamically computing a master key from a recovery phrase, in accordance with some embodiments of the present invention. The features of FIG. 4 correspond to the features of FIG. 3, using the recovery phrase (generated during the set-up process) instead of the master phrase.

At 402, the Recovery Phrase (also referred to herein as recovery indication) is received from the user. The Recovery Phrase corresponds to the Master phrase. The Recovery Phrase is automatically generated when the Master Phrase is initially provided by the user, as part of the set-up process, as described herein.

Optionally, a recovery indication indicating that the data entered by the user for the master phrase is actually the recovery phrase, is received.

At 403, the Recovery Phrase may be converted into a numerical code, for example, based on the BIP-39 standard, and/or other approaches. For example, the recovery phrase includes a seed phrase of a list of words, where a mapping function maps the seed phrase to one or more recovery numbers. The path key is computed from the KDF that receives the recovery salt and the recovery number(s).

At 404, the recovery salt associated with the indication of the user is obtained. The recovery salt is computed during the set-up process.

The recovery salt may be stored as clear text. The recovery salt may be stored in as metadata in a metafile associated with the user. The recovery salt may be stored, for example, on a server and/or on the client terminal of the user.

The master key is dynamically computed from the recovery phrase and the recovery salt.

At 406, the outcome of the conversion of the Recovery Phrase into the numerical code using the BIP-39 standard is inputted into the KDF with the recovery salt.

408-428 correspond to, and are as described with reference to 308-328 of FIG. 3, generating the same MasterKey in 428 as in 328.

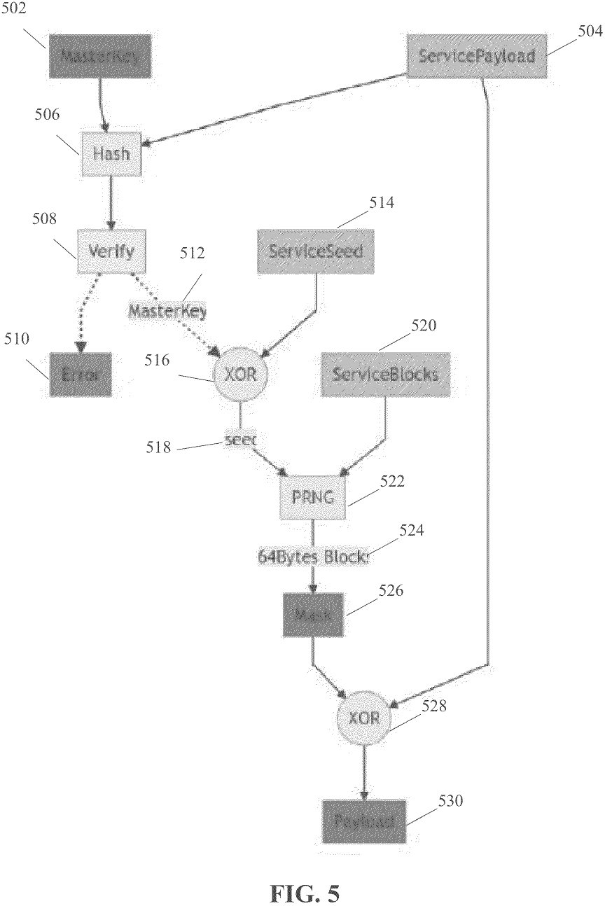

Reference is now made to FIG. 5, which is a dataflow diagram of an exemplary process for dynamically computing any one of multiple service passwords from a single same MasterKey and a service salt, in accordance with some embodiments of the present invention. The flow depicted in FIG. 5 uses the MasterKey computed, for example, as described with reference to FIG. 3 and/or FIG. 4. Given the same single MasterKey, different service-specific credentials (e.g., service specific password to access a respective secure application) may be deterministically derived from metadata, for example, stored in a metafile, optionally in clear text, for example, stored on the server and/or on the client terminal of the user. Each one of the service passwords for accessing one respective secure applications is computed from the same master salt and from a respective unique service payload associated with the respective secure application. The respective unique service payload is created during the set-up process. Each secure application is associated with a certain service password and a certain service payload.

Service elements may be, for example, base64 (or other values) encoded inside JSON description (or other implementation). Services may be indexed according to their type.

The metadata for the certain service may be stored as clear text. The metadata for the certain service may be stored, for example, on a server and/or on the client terminal of the user. The metadata for the certain service may be stored in a metafile associated with the user.

The following is an example of metadata for a certain service:

{
“Algorithm Version”: “1”,
“ServiceSeed”:
“Qcnk0Y0WX1+zmXsiEzVyXEMbm6BazfQGc/sKPfoPaLz6dqckefClfJhi2DPR3r3sUZ
rux3VW6wb4KWZzpnqtjA==”,
“ServicePayload”:
“C7Z00hDbd3Jaa5cmPf66xtyat9ujXjbHZfq+L/to6KmSLtgkGw23HYN9KarYZhg6V+I/
yJQ8sdCIf+FdlawSo0X/y2/fGf+QY=”,
“ServiceIntegrity”:
“PReCKB/eld6pGta19SRQhdMbFUoHJMv++6q5dCwYn3LsKiKgUgK4oMlfHFPv9Yc
0WJeKueTvvLtXDYYGfyduwA==”,
“ServiceBlocks”: “2”,
“ServiceType”: “1”, // 1=protected, 2=shared, 3=backup
}

At 502, the MasterKey is obtained. The MasterKey is computed from the Master Phrase entered by a user, for example, as described with reference to FIG. 3.

At 504, the ServicePayload associated with the selected secure application and associated with the indication of the user is obtained, for example, from the metadata of the certain service. The ServicePayload is created during the set-up process.

At 506, the MasterKey and the ServicePayload are inputted into a cryptographic hash function (also referred to herein as a dynamic service hash).

At 508, the outcome of the hash function is compared to the ServiceIntegrity, obtained for example, from the metadata of the certain service.

At 510, in response to the outcome of the dynamic service hash function being different than the ServiceIntegrity, an error is generated. The process may be aborted. An indication of the error may be presented on a display of the client terminal.

At 512, in response to the outcome of the dynamic service hash function matching the ServiceIntegrity, the verified MasterKey is provided.

At 514, the ServiceSeed is obtained, for example, from the metadata of the certain service. The service seed is associated with the indication of the selected one secure application and the indication of the user. The service seed is created during the set-up process.

At 516, an operation (e.g., XOR) is applied to the MasterKey and ServiceSeed.

At 518, the outcome of the operation (e.g. XOR) of the MasterKey and ServiceSeed is stored as a seed.

At 520, a number of ServiceBlocks to extract is obtained, for example, from the metadata of the certain service.

At 522, a PRNG is instantiated with the seed (of 518), for example, according to the Block2Int process.

At 524, the number of ServiceBlocks (as in 520), each of a defined size (e.g., 64 bytes) are pulled from the PRNG.

At 526, the number of ServiceBlocks pulled from the PRNG are stored in a Service Mask. The Service Mask is generated by extracting multiple service blocks from the PRNG

At 528, an operation (e.g., XOR) is applied to the Service Mask (of 526) and with ServicePayload. The ServicePayload may be obtained, for example, from the metadata of the certain service.

At 530, the outcome of the operation (e.g., XOR) of Mask and ServicePayload is stored as Payload. The service password is dynamically computed from the payload and the ServicePayload, for example, using the following process: a password seed stored in the service payload is obtained. A set of password constraint rules may be obtained, for example, stored in the service payload. A temporary seed is set to the password seed. An alphanumeric data structure is initialized with default values. In multiple iterations: a PRNG is instantiated with temporary seed, for each constraint rule of the set of password constraint rules, one character from the alphanumeric data structure is selected, and the selected one character is placed in a temporary array. For another set of multiple iterations, where the number of iterations is according to a target number of characters in the service password, one character is randomly selected from the alphanumeric data structure. The selected one character is placed in the temporary array. The temporary array is shuffled. Each of one of multiple heuristic functions is applied to the temporary array. The temporary array is provided as the service password. Examples of heuristic functions include: repeating characters, linear relationship between alphanumeric characters, and a start with at least one digit. When at least one of the heuristic functions fails, a temporary seed is set to a random value obtained from the PRNG. The temporary array is cleared. The iterations are re-performed.

The following is an exemplary pseudocode for generating the Payload for a certain service, which may correspond to the dataflow depicted with reference to FIG. 5:
h = hash(MasterKey II ServicePayload)
if h != ServiceIntegrity { panic }
seed = ServiceSeed ^ MasterKey
prng = PRNG(seed)
mask = prng.Pull(64 * ServiceBlocks)
payload = mask ^ ServicePayload

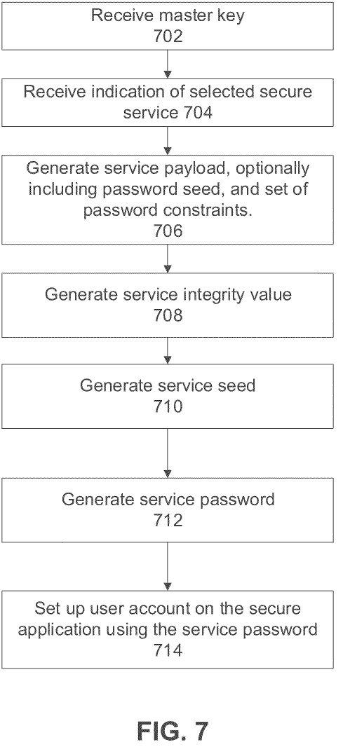

The following is an example of a service payload for one secure application (e.g., Reddit) which is generated as described herein and/or used during the dataflow described with reference to FIG. 5 and/or FIG. 7:

{
“username”: “john.connor@sky.net”,
“PasswordSeed”:
H+z2rl3T98Tle9CxBe9etCRXEITiUy8fEh6WajanqwAv2/cs8AUTYwiEuKCXGuY/yzlj
uMZfS3HbG6ExYrFkWg==”,
“padding”: “jA9EyzKtL44R2cBR4VQ9yQR27TEdRLwolSVbnO7rYYlIkUVw7YC”, //
used to align to “PasswordLength”: “12”,
“ServiceData”: {
“name”: “Reddit”,
“code”: “reddit”,
“logo”: “www(dot)passback(dot)com/public/logos/reddit.svg”,
“loginPage”: “www(dot)reddit(dot)com/”,
“customPasswordRules”: {
“forbiddenCharacters”: “@\V”,
“minimalDigits”: “2”,
“minimalLowerCase”: “1”,
“minimalUpperCase”: “1”,
“minimalSpecialGroup”: “1”,
},
“heuristics”: “func1,func2”, // list of global heuristic function to check a password
}
}

When parsing the JSON payload, the padding key may be ignored.

The PasswordSeed field of the Payload may be used to derive the service password.

Exemplary heuristic functions include: repeating characters; linear relationship (e.g., 1,2,3 or 3,2,1 or A,B,C or C,B,A); start with digits.

An exemplary pseudocode for computing the service password from the Payload is now provided. The Payload may be computed, for example, as described with reference to FIG. 5.
1. Instantiate a datastructure (e.g., array) storing alphanumeric characters and/or symbols with default values.
2. Set tmp_seed to PasswordSeed. The PasswordSeed is a field of the Payload, as described herein.
3. Repeat the following, optionally at most a predefined number (denoted N) of times:
   3.1 Instantiate the PRNG with tmp_seed.
   3.2 For each minimal constraint rules (e.g., defined by the secure application, which may be stored in the service payload), select one character from the generated alphabet, and place in tmp_array.
   3.3 Repeat PasswordLength times: Select a random character from alphabet and place in tmp_array.
   3.4 Shuffle tmp_array.
   3.5 Apply each heuristic_function, if any of them fails:
      3.5.1 Set tmp_seed to a 16 (or other value) byte random value from the PRNG.
      3.5.2 Clear tmp_array
      3.5.3 Return to step 3.1
   4.Return the tmp_array as the SerivePassword.

The following are exemplary characters which may be included in the ServicePassword for the respective service, subject to the customPasswordRules defined by the respective Payload for the respective service: Digits selected from 0-9 (total of 10), Uppercase letters selected from A-Z (total of 26), lowercase letters selected from a-z (total of 26), and special group (e.g., symbols) selected from $ . [ ] @ - / # * & _ ! (total of 12).

Reference is now made to FIG. 6, which is a flowchart of a set-up process for computing data for obtaining a master key from a master phrase, in accordance with some embodiments of the present invention. The master key may be used to access any one of multiple secure applications, as described herein. The set-up process sets up the data used to access one or more secure applications, for example, as described with reference to FIGS. 3-5. FIG. 6 may be reexecuted, for example, to reset the master phrase and/or generate new data (e.g., salt), for example, using the recovery password when the master phrase is lost.

It is noted that the process of generating some data (e.g., salts) is not necessarily described herein for each data element. In such cases, different approaches may be used, for example, randomly using TRNG and/or PRNG as described herein and/or other approaches.

At 602, a master phrase is received from a user, for example, entered via a user interface. Optionally, an indication of one secure application of multiple secure applications for access, is received. It is noted that the indication of the secure application for access may be received at a later stage, for example, after the master key is established.

At 604, the master salt is created and stored, for example, in a file associated with an indication of the user.

At 606, the master-verification-salt is created and stored, for example, in the file associated with the indication of the user.

At 608, the dynamic master hash is computed and stored, for example, in the file associated with the user. The dynamic master is computed as a cryptographic hash of a pathkey and the master-verification-salt. The pathkey is computed from the KDF that receives the master salt and master phrase as input.

At 610, the mask for application to the path key for generation of a master key, is generated.

The mask may be generated as the outcome of a mathematical operation (e.g., XOR) of the master key and the path key. The mask is stored in association with the indication of the user, for example, in the file associated with the user.

At 612, the master key, which is dynamically computed from the master phrase and the master salt, is provided. The master key is used to generate unique service passwords, for example, as described with reference to FIG. 7.

At 614, a recovery phrase and/or recovery data (e.g., salts) may be generated. The recovery phrase enables recovering the master key instead of the master phrase, for example, when the master phrase is lost. A new master phrase may be selected using the recovery phrase. It is noted that the master key generated from the recovery phrase is same as the master phrase generated from the master phrase.

Optionally, the recovery phrase is generated using the following exemplary process. One or more recovery numbers are generated. A mapping function maps the recovery number(s) to a seed phrase of a list of words, where the recovery phrase is the seed phrase. The seed phrase may be presented on a display (e.g., for the user to copy down) and/or printed.

The recovery salt may be generated. The recovery salt is stored in association with a recovery indication and the indication of the user, for example, in the file associated with the user.

The recovery-verification-salt may be generated and stored in association with the recovery indication and the indication of the user, as described herein.

A recovery-hashkey may be generated and stored in association with the recovery indication and the indication of the user (e.g., in the file), as described herein. The recovery-hashkey may be computed as a cryptographic hash of the path key and the recovery-verification salt. The path key is computed from the KDF that receives the recovery salt and recovery phrase as input.

A recovery mask that when applied to the path key generates the master key, is computed and stored in association with the recovery indication and the indication of the user (e.g., in the file), as described herein.

Reference is now made to FIG. 7, which is a flowchart of a set-up process for computing data for obtaining a service password from a master phrase, in accordance with some embodiments of the present invention. The flowchart described with reference to FIG. 7 may be executed for each secure application, using the same master phrase, to set up and/or change the unique service password for the respective secure application.

At 702, the master key, which is computed as described herein (e.g., as described with reference to FIG. 6, and/or FIGS. 3-4) is received.

At 704, an indication of the secure application for which the payload and/or service password is being generated may be received, as described herein.

At 706, the service payload for the selected service is generated. The service payload may be stored in association with an indication of the selected secure application and the indication of the user, for example, in the file of the user.

A password seed may be generated and stored in the service payload.

A set of password constraint rules may be obtained (e.g., from the selected secure application) and stored in the service payload.

At 708, the service integrity value is generated. The service integrity value may be computed as a hash of the master key and the service payload. The service integrity value may be stored in association with an indication of the selected secure application and the indication of the user, for example, in the file of the user.

A dynamic service hash, computed as a hash of the master key and the service payload, is verified when the dynamic service hash matches the service integrity value.

At 710, the service seed is received and/or generated. The service seed may be stored in association with the indication of the selected secure application and the indication of the user, for example, in the file of the user.

At 712, a service password is dynamically computed from the master key and the service payload, for example, using the following exemplary process:

A seed is generated by computing an operation (e.g., XOR) between the service seed and the master key. A PRNG with the seed is initialized with the seed. A service mask is generated by extracting multiple service blocks from the PRNG. A payload is generated by computing an operation (e.g., XOR) between the mask and the service payload.

The service password is dynamically computed from the payload and service payload, for example, using the following process: a password seed stored in the service payload is obtained. A set of password constraint rules may be obtained, for example, stored in the service payload. A temporary seed is set to the password seed. An alphanumeric data structure is initialized with default values. In multiple iterations: a PRNG is instantiated with temporary seed, for each constraint rule of the set of password constraint rules, one character from the alphanumeric data structure is selected, and the selected one character is placed in a temporary array. For another set of multiple iterations, where the number of iterations is according to a target number of characters in the service password, one character is randomly selected from the alphanumeric data structure. The selected one character is placed in the temporary array. The temporary array is shuffled. Each of one of multiple heuristic functions is applied to the temporary array. The temporary array is provided as the service password. Examples of heuristic functions include: repeating characters, linear relationship between alphanumeric characters, and a start with at least one digit. When at least one of the heuristic functions fails, a temporary seed is set to a random value obtained from the PRNG. The temporary array is cleared. The iterations are re-performed.

At 714, the service password is provided for setting up an account of the user on the selected secure application for future secure access to the secure application. For example, when setting up a new account for the user on the secure application, the dynamically computed service password is entered into the “password” field of the secure application.

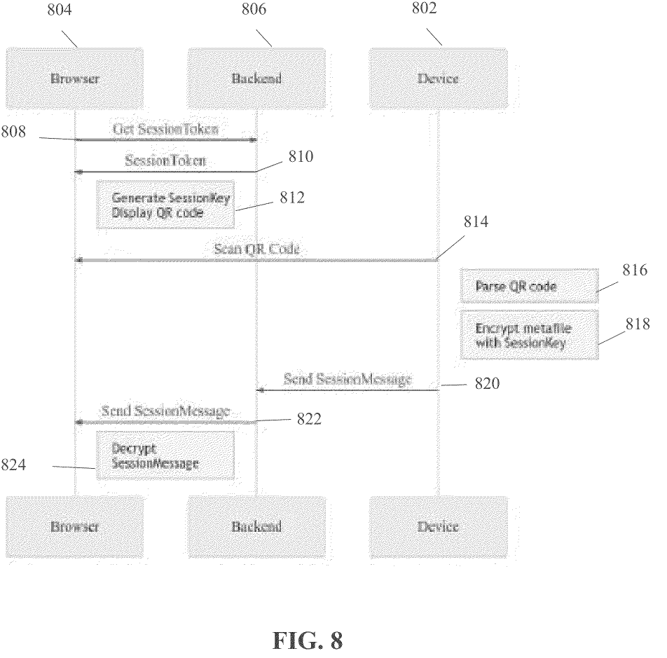

Reference is now made to FIG. 8, which is a dataflow diagram of an exemplary process for setting up an encrypted data channel for communication between a device 802 (e.g., client terminal, mobile device, laptop, desktop) and a browser 804, via a backend 806, optionally over a network, in accordance with some embodiments of the present invention. Device 802 may execute a mobile app, as described herein. Browser 804 may be running on another computing device (e.g., laptop, desktop) that may be different than device 802. Browser 804 may be accessing a secure application hosted on a network server. The secure application is accessed using a session key dynamically generated from the user entered master phrase, as described herein. Backend 806 may be implemented as, for example, as a network connected server, a web application hosted by a web server accessed by browser 804, and/or a mobile application installed on a mobile device implementation of device 802. The web application implementation may have similar feature parity as the mobile app implementation. The web application may be paired with the mobile app.

Metadata, such as the computed service password, master salt, recovery salt, verify salt, and hash key, and the like, may be sent between device 802 and browser 804 via backend 806. Backend 806 is not (e.g., never) exposed to the encryption key, and provides (e.g., only provides) synchronization and/or exchange services.

One or more (optionally all) of the following may be provided: The connection between device 802 and backend 806 is encrypted. The connection between browser 804 and backend 806 is encrypted. After the secure connection is established by device 802, browser 804, and backend 806, the metadata (e.g., service password) is encrypted and sent over from device 802 to browser 804. Once copy is verified, the connection may close. Once the session is closed, the session token and any other information may be deleted from memory.

At 808, browser 804 requests a session token from backend 806. The request may be triggered by opening a web site of the web application hosted by a web server using browser 804 of another device, for example, a laptop and/or desktop computer. A session token (e.g., universally unique identifier (UUID)) is generated, optionally randomly, by backend 806. The session token is used to identify sessions between different endpoints.

At 810, backend 806 provides the session token to browser 804.

At 812, browser 804 generates a session key and presents a QR code. The QR code is presented on the display of the device within browser 804 running on the other device. The session key may include a public and private key, generated based on an asymmetric encryption protocol. Alternatively, keys are generated based on a symmetric encryption protocol.

An exemplary QR code, which is not necessarily limiting, is now described. The QR code may encode the following format <Version>$<Env>$<SessionToken>$<SessionKey><TimeCode>, where: Version denotes the respective version; Env denotes environment selected from : d - development, s - staging, b - beta (reserved), p - production; SessionToken which is determined by the backend 806 as described herein, SessionKey which is for example 64 random bytes generated by browser 804 and may be encoded as base64 string; TimeCode denotes a value generated by backend 806 to check the session start time. The Env is provided to avoid or reduce a misuse of web-sync when an application from one environment tried to scan a QR-code from another environment. Spending only one character of QR-code payload, such a mismatch situation may be detected and handled. An example of the QR code is:

1$d$91de75aa68c¢39528972bfa6404752d7a$c2RqZmhzamtkZmhzZGprZmh3b2lvc2pkZ
mtsanNkamZvaXNkamZvaWRzamZpb3NkamZpb3Nkam9panNka2Zq

At 814, device 802 scans the QR code presented on the display of the device within browser 804. For example, using a camera of device 802 and the mobile application installed on device 802. Scanning the QR code creates a pairing between the session of browser 804 and the mobile app installed on device 802.

At 816, device 802 parses the QR code.

At 818, device 802 encrypts the metadata with the session key (e.g., asymmetric key) to create a session message. Device 802 may safely pass all the user’s metadata to browser 804. Upon entering the master phrase inside the mobile application running on device 802, the user is able to device the service password for accessing the target secure application within browser 804. Any metadata changes made in the mobile app running on device 802 or in browser 804 are propagated to the other side.

Independent modes for the web app may require the user to provide credentials to the cloud service used for sync/backup of user meta-data. This may allow the mobile device(s) 802 and web browser(s) 804 to operate independently, which may help in case a mobile device is inaccessible or not working.

In some embodiments, the web app as compared to the mobile app may be implemented with a lack of auto-fill functionality. Without auto-fill the user may be required to copy/paste account credentials from the mobile app running on device 802 to browser 804. In other embodiments, browser extension code may be implemented to provide the auto-fill functionality to the browser. The web app and browser extension may be independent, but when used together may improve user experience allowing the auto-fill functionality on service login screens in any browser tab.

The session message may be, for example, a JSON wrapper for the metadata payload during transfer from device 802 to browser 804 through backend 806. The wrapping object may have an HMAC field (64 bytes) and a payload field (aligned to 64 bytes) which encodes a JSON object. Binary fields are base64 encoded. An example is now provided:

{
“type”: “websync/SendEncryptedMetadata”,
“payload”: {
“version”: 1,
“hmac”:
“1mLFLDJvzon5leCHGGqnOOZVsinlg8bRz6317qW4O7w0oGYwMtDOGgyFz
u⅝SZUv5E9II0rU3rHMaC37gNfjw==”,
“data”: {
“sessionToken”: “25ffa39a-9c66-40ad-8377-26855625cae5”,
“metadataToken”: “acb0a97c-385a-438f-9dae-f5e538213cd7”,
“payload”:
“Lsdw+c+B8w05PC9IioCAXkho3T0PczpkkCR3p2HyGEGijU+1HGaCqYNxP4
bX+OsCy89bfn6ahMQ3KTQ85SpWETf2cBN/}
}
}

The metadata payload may include information regarding the session UUID and the encrypted payload. The HMAC is computed over the data field. Minimized JSON with fields sorted alphabetically may be used.

The metafile data may be encrypted as a single payload, optionally with an added field of random “padding” used to align to 64 byte blocks (or other values).

Symmetric and/or asymmetric encryption may be used, with SessionKey as key (which is received from browser 804), the Initial vector (IV) value for the Encryption may be:

WRNF0bFwLWzi+4GbUyBywrk1utHnt8rGfrP6ri6UY1w= which is a base64 encoded 32 byte array.

A hash function may be used for computing the hash of the encrypted payload.

A pseudo code for the payload is now provided:
payload = ENCRYPT(SessionKey, metafile)
b64payload = base64.encode(payload)
data[“sessionToken”] = SessionToken
data[“metadataToken”] = MetadataToken
data[“payload”] = b64payload
hmac = HASH(SessionKey, data)

At 820, the session message is sent from device 802 to backend 806.

At 822, the session message is sent from backend 806 to browser 804.

At 824, browser 804 decrypts the session message, for example, using the following process: Compute the hash of the data part and compare it to the HMAC field, using the SessionKey. Verify that the SessionToken is correct. Decrypt the payload using the SessionKey. Ignore the padding field.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant master phrases will be developed and the scope of the term master phrase is intended to include all such new technologies a priori.

As used herein the term “about” refers to ± 10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method for dynamic deterministic generation of a user password for access to a secure application, comprising:
receiving from a user interface, a master phrase entered by a user, and an indication of one secure application of a plurality of secure applications for access by the user;
receiving a master salt associated with an indication of the user;
dynamically computing a master key from the master phrase and the master salt;
receiving a service payload associated with an indication of the one secure application and the indication of the user;
dynamically computing a service password from the master key and the service payload;
and providing the service password for accessing the one secure application.

2. The method of claim 1, wherein each one of a plurality of service passwords for accessing a plurality of secure applications is computed from the master salt and a respective service mask stored in the service payload associated with a respective secure application, wherein each secure application is associated with a certain service password and a certain service payload storing the service mask.

3. The method of claim 1, wherein the master key is computed by inputting the master phrase and the master salt into a key derivation function (KDF) that generates the master key of a predefined fixed size.

4. The method of claim 1, further comprising:
computing a path key from a KDF that receives the master salt and master phrase as input;
receiving a master-verification-salt associated with the indication of the user;
computing a dynamic master hash of the pathkey and the master-verification-salt;
receiving a master-hashkey associated with the user, the master-hashkey computed as a cryptographic hash of the master phrase and the master salt;
verifying the path key as the master key when the dynamic master hash matches the master-hashkey.

5. The method of claim 4, further comprising:
in response to the verifying, the verifying the path key as the master key comprises computing the master key by applying a mask to the path key.

6. The method of claim 1, further comprising: in response to the computation of the service password, deleting the master phrase, the master key, and the service password, from a memory.

7. The method of claim 1, wherein the master phrase entered by a user comprises a recovery phrase corresponding to the master phrase, and further comprising:
receiving a recovery indication indicating that the master phrase entered by the user comprises the recovery phrase;
receiving a recovery salt associated with the indication of the user; and
wherein dynamically computing the master key from the master phrase and the master salt comprises dynamically computing the master key from the recovery phrase and the recovery salt.

8. The method of claim 7, further comprising:
computing a path key from a KDF that receives the recovery salt and recovery phrase as input;
receiving a recovery-verification-salt associated with the user;
computing a dynamic recovery hash of the path key and the recovery-verification-salt;
receiving a recovery-hashkey associated with the user, the recovery-hashkey computed as a cryptographic hash of the recovery phrase and the recovery salt;
in response to the dynamic recovery hash matching the recovery-hashkey, computing the master key by applying a recovery mask to the path key.

9. The method of claim 8, wherein the recovery phrase comprises a seed phrase of a list of words, and further comprising mapping using a mapping function the seed phrase to at least one recovery number, wherein the path key is computed from the KDF that receives the recovery salt and the at least one recovery number.

10. The method of claim 1, wherein dynamically computing the service password from the master key and the service salt, comprises:
receiving a service seed associated with the indication of the certain one secure application and the indication of the user;
receiving a service payload associated with the indication of the certain one secure application and the indication of the user;
generating a seed by computing an operation between the service seed and the master key;
initialize a pseudo-random number generator (PRNG) with the seed;
generating a service mask by extracting a plurality of service blocks from the PRNG;
generating a payload by computing an operation between the mask and the service payload; and
dynamically computing the service password from the payload and service payload.

11. The method of claim 10, further comprising:
computing a dynamic service hash of the master key and the service payload;
receiving a service integrity value stored in association with an indication of the certain one secure application and the indication of the user;
verifying that the dynamic service hash matches the service integrity value.

12. The method of claim 10, wherein dynamically computing the service password from the payload and service payload comprises:
receiving a password seed stored in the service payload;
receive a set of password constraint rules stored in the service payload;
set a temporary seed to the password seed;
initialize an alphanumeric data structure with default values;
in a plurality of iterations:
instantiate a PRNG with temporary seed;
for each constraint rule of the set of password constraint rules, select one character from the alphanumeric data structure, and place the selected one character in a temporary array;
for another plurality of iterations according to a target number of characters in the service password, randomly select one character from the alphanumeric data structure and place the selected one character in the temporary array;
shuffle the temporary array;
apply each of a plurality of heuristic functions to the temporary array; and
provide the temporary array as the service password.

13. The method of claim 12, wherein the plurality of heuristic functions are selected from the group consisting of: repeating characters, linear relationship between alphanumeric characters, and a start with at least one digit.

14. The method of claim 12, wherein at least one of the plurality of heuristic functions fails, set a temporary seed to a random value obtained from the PRNG, clear the temporary array, and repeat plurality of the iterations.

15. A computer implemented method of setting up a master phrase and service password of a user for access to a secure application, comprising:
receiving from a user interface, a master phrase entered by a user, and an indication of one secure application of a plurality of secure applications for access by the user;
generating a master salt;
storing the master salt in association with an indication of the user;
dynamically computing a master key from the master phrase and the master salt;
generating a service payload;
storing the service payload in association with an indication of the one secure application and the indication of the user;
dynamically computing a service password from the master key and the service payload; and
providing the service password for setting up an account of the user on the one secure application for future secure access to the one secure application.

16. The method of claim 15, further comprising:
computing a path key from a KDF that receives the master salt and master phrase as input;
generating a master-verification-salt;
storing the master-verification-salt in association with the indication of the user;
computing a dynamic master hash as a cryptographic hash of the pathkey and the master-verification-salt; and
storing the dynamic master hash in association with the indication of the user.

17. The method of claim 16, further comprising:
generating a mask for application to the path key for generation of a master key; and
storing the mask in association with the indication of the user.

18. The method of claim 17, wherein generating the mask comprises:
generating a random value for the master key; and
storing the mask as the outcome of an XOR mathematical operation of the master key and the path key.

19. The method of claim 15, further comprising:
generating a recovery phrase, wherein when the recovery phrase is provided instead of the master phrase, the master key generated from the recovery phrase is same as the master key generated from the master phrase;
generating a recovery salt; and
storing the recovery salt in association with a recovery indication and the indication of the user.

20. The method of claim 19, further comprising:
generating at least one recovery number;
mapping using a mapping function the at least one recovery number to a seed phrase of a list of words; and
presenting on a display and/or printing the seed phrase,
wherein the recovery phrase comprises the seed phrase.

21. The method of claim 19, further comprising:
generating a recovery-verification-salt;
storing the recovery-verification-salt in association with the recovery indication and the indication of the user;
computing a path key from a KDF that receives the recovery salt and recovery phrase as input;
computing a recovery-hashkey as a cryptographic hash of the path key and the recovery-verification salt;
storing the recovery-hashkey in association with the recovery indication and the indication of the user; and
computing a recovery mask that when applied to the path key generates the master key.

22. The method of claim 15, wherein dynamically computing the service password from the master key and the service salt, comprises:
receiving a service seed associated with the indication of the certain one secure application and the indication of the user;
receiving a service payload associated with the indication of the certain one secure application and the indication of the user;
generating a seed by computing an XOR operation between the service seed and the master key;
initialize a pseudo-random number generator (PRNG) with the seed;
generating a service mask by extracting a plurality of service blocks from the PRNG;
generating a payload by computing an XOR operation between the mask and the service payload; and
dynamically computing the service password from the payload and service payload.

23. The method of claim 15, further comprising:
computing a dynamic service hash of the master key and the service payload;
receiving a service integrity value stored in association with an indication of the certain one secure application and the indication of the user;
verifying that the dynamic service hash matches the service integrity value.

24. The method of claim 15, wherein dynamically computing the service password from the payload and service payload comprises:
receiving a password seed stored in the service payload;
receive a set of password constraint rules stored in the service payload;
set a temporary seed to the password seed;
initialize an alphanumeric data structure with default values;
in a plurality of iterations:
instantiate a PRNG with temporary seed;
for each constraint rule of the set of password constraint rules, select one character from the alphanumeric data structure, and place the selected one character in a temporary array;
for another plurality of iterations according to a target number of characters in the service password, randomly select one character from the alphanumeric data structure and place the selected one character in the temporary array;
shuffle the temporary array;
apply each of a plurality of heuristic functions to the temporary array; and
provide the temporary array as the service password.

25. The method of claim 24, wherein the plurality of heuristic functions are selected from the group consisting of: repeating characters, linear relationship between alphanumeric characters, and a start with at least one digit.

26. The method of claim 24, wherein at least one of the plurality of heuristic functions fails, set a temporary seed to a random value obtained from the PRNG, clear the temporary array, and repeat plurality of the iterations.

27. The method of claim 22, further comprising:
generating the service seed;
storing the service seed in association with the indication of the certain one secure application and the indication of the user;
receiving a plurality of password constraint rules defined by the certain one secure application;
generating a password seed;
generating the service payload, including the plurality of password constraint rules defined by the certain one secure application, and the password seed; and
storing the service payload in association with an indication of the certain one secure application and the indication of the user.

28. The method of claim 23, further comprising:
computing the service integrity value as a hash of the master key and the service payload; and
storing the service integrity value in association with an indication of the certain one secure application and the indication of the user.
